(19) United States
(12) Patent Application Publication
(10) Pub. No.: US 2011/0072037 A1
(43) Pub. Date: Mar. 24, 2011

(54) INTELLIGENT MEDIA CAPTURE, ORGANIZATION, SEARCH AND WORKFLOW

(75) Inventor: Carey Leigh Lotzer, Sachse, TX (US)

(73) Assignee: Carey Leigh Lotzer, Sachse, TX (US)

(21) Appl. No.: 12/885,593

(22) Filed: Sep. 20, 2010

Related U.S. Application Data
(60) Provisional application No. 61/276,913, filed on Sep. 18, 2009.

(51) Int. Cl. G06F 17/30; H04N 7/173

(52) U.S. Cl. 707/769; 725/115; 707/E17.014

(57) ABSTRACT

A media capture system employing a method for capturing a media stream and embedding time-based links into the resulting output for the purpose of associating the media information with other artifacts and thereby having the capability of searching for one or more pieces of information, retrieving that information, and displaying segments of the media content based on the search criteria specified by the user. The queried information may be text descriptions, pointer titles, thermal reading levels, motion periods and/or motion levels, object types, as well as other interesting information.

### CROSS-REFERENCE TO RELATED APPLICATIONS

This application claims benefit to provisional application 61/276,913, entitled “Intelligent Media Capture, Organization, Search and Workflow”, filed on Sep. 18, 2009, the entire contents of which are hereby incorporated by reference.

### BACKGROUND OF THE INVENTION

Overview

The present invention is generally related to media capture and organization, and, more specifically, to search and workflow enhancements.

There are various challenges currently facing audio and video consumers in relationship to the storage and retrieval of large amounts of media. Media files are difficult to search for, index and to watch or hear only segments of interest. Generally speaking, once a presentation has been captured and stored, it is the viewers' responsibility to determine what interests them by title and the media file must be watched or listened to in its entirety before the true relevant information can be distinguished from the content as a whole. A conference or training session has many levels of varied information not all, of which, is relative, of interest, or even comprehended by all viewers. Therefore, it is exceedingly beneficial to have the ability to view material at differing points of interest.

The current invention provides a mechanism not only to reduce the amount of information needed to search through, but it also provides the ability to associate many different artifacts, such as pictures, documents, binary files, URLs, markers, captions, descriptions, user information, closed caption segments, custom fields, etc., considered “associated content”, with the media files or even time slices within the media files for immediate access based on personal interest. This provides viewers whom may have missed the original presentation with the ability to watch or listen at a later date as well as preserving valuable information for the future.

The system can be distributed either widely on a network or it may be self-contained on a single computing system. A simple example of a distributed system is shown in FIG. 1. The example describes a web client sending and receiving message packets to and from an encoder and a data store. The encoder communicates with a camera and has the ability to send and receive information to it. The encoder also has the ability to store information to a media disk and send and receive messages from a data store. The data delivered from the camera to the encoder is either compressed, if it has an on-board compression system, or uncompressed and audio and/or video. The data store and/or media disk holds and retrieves the “associated content”.

Another example configuration can be seen in FIG. 2. The system described has one or more web client applications which send and receive information to/from one or more encoders which have access to one or more cameras and/or microphones.

The figures described are example configurations of the present invention. The client, encoder and data store may also be configured to reside on a single computing system as well as many computing systems over a network. The possible configurations are limitless in scalability and complexity yet can be as simple as configured on a single laptop.

A workflow is comprised of “associated content” which is configured to follow and possibly enhance the captured media over time by providing content synchronized with the media playback. The workflow can be copied, changed, deleted, or appended to as needed. Security measures may be applied so that individuals with differing levels or no access are handled according to their access privileges.

Example workflow implementations could include usage in law firms, technical companies, medical environments, various conferences, educational environments, retail as well as real estate and others. Content stored and indexed as “associated content” could include one or more voicemail, text, audio, emails, documents, closed caption objects, software programs, medical records, instructions, manuals, referring hyperlinks or other URLs, images, subject matter, depositions, video, thumbnails, additional “associated content”, including versioned material, etc. The information contained in these artifacts may be searched and retrieved for review. In addition to performing searches, the artifacts can be viewed, listened to, played or interacted with, given the viewer/player has the correct privileges, decoders and software needed to view/play the material. Also, if given proper access, the material may be edited, appended and tracked, where each retrieval and change is tracked and viewable for auditing purposes. The media can be played at its lower or full resolution from the marker points which are injected into the media. Higher, additive resolutions may be added later when the computer is not in use

### SUMMARY OF THE INVENTION

The present invention employs a method for capturing a media stream and embedding time-based links into the resulting output for the purpose of associating the media information with other artifacts. Ushering in the next wave of technological advancements in video includes the adaptation of digital video capture with embedded searchable content and other related objects. The video recorder is no longer a passive capture device for entertainment purposes only—but a sophisticated archival and research tool used to enhance business, learning and satisfy the need for a meaningful deposition and investigation tool.

In business, the present invention can be utilized as a meeting recorder and documentation tool. In the educational arena, it can be used to provide scheduled streaming media delivered from the classroom to the student's desktop regardless of the time or distance separating them. In the law firm, this system may be used for depositions and interviews. In the precinct, the present invention may be used to document suspect interviews and to capture confessions. In the medical area, the tool can be used to gather patient information and to document operative procedures. In addition, the entertainment industry may utilize the present invention as a coaching tool to review play execution and provide instruction.

The present invention is a sophisticated and scalable collection of tools which meet the needs of these industries while providing favorable cost returns for the business investment by providing building blocks which can be groomed and grown as the business requirements expand without the original investment dollars needed again in a new investment. In addition, as advancements in hardware and software are made and introduced in the marketplace, the business may expand in steps which correlate to the improvements desired.

Traditional video recording is rapidly moving away from its analog VCR and now, digital video recording past into a networked future that combines sophisticated digital video technology, Internet protocols and powerful search and retrieval techniques to create intelligent, network-centric video recording systems that are at the heart of these new generation of integrated documentation and training systems. The intelligence behind the present invention networked video recording system is attributed to the use of these technologies and protocols as well as applying powerful database techniques and embedded monikers within the video data itself.

The present invention employs a network infrastructure that would be familiar to any IT professional, and offers a number of advantages over analog predecessors, including lower total cost of ownership, greater flexibility and scalability, better image quality and built-in intelligence. As importantly, these technical advances open the door to applying computer-based documentation, indexing, search and retrieval methods to the video data gathered for the purpose of creating intelligent, proactive documentation systems capable of categorizing video content and support documentation/records in a seamless fashion thereby enabling the enterprise-level solution to the media librarian.

In the recent past, digital video recorders (DVRs) arrived and replaced videocassette recorders with remarkable speed; and more recently, IP-based digital encoders and cameras began replacing their analog predecessors in ever-increasing numbers. Yet these solutions, however advanced or clear the signal stored, provide one chief tool for investigators and students—the rewind button.

The present invention offers a suite of tools to do away with this frustrating and limited interface control by offering the ability to interactively search through limitless amounts of content from the media file down to the topic desired. The current invention provides a video software technology where it propels video recording from an after-the-fact, capture, reload and replay tool into a proactive asset that will enable the business to quickly and accurately locate not only the correct video, but the actual frame of interest within the correct video.

In addition, data is unquestionably the lifeblood of today's digital organization. Storage solutions remain a top priority in IT budgets precisely because the integrity, availability and protection of data are vital to business productivity and success. But the role of information storage far exceeds day to day functions. Enterprises are also operating in an era of increased uncertainty. IT personnel find themselves assessing and planning for more potential risks than ever before, ranging from acts of terrorism to network security threats. A backup and disaster recovery plan is essential, and information storage solutions provide the basis for its execution.

Businesses are also subject to a new wave of regulatory compliance legislation that directly affects the process of storing, managing and archiving data. This is especially true for the financial services and healthcare industries, which handle highly sensitive information and bear extra responsibility for maintaining data integrity and privacy.

The technological issues challenging providers of digital video recording services can be categorized as the following:

Content categorization

Content search/retrieval and independent playback from the point of interests

Content security

Network and storage reliability

Cost of management

System scalability

The present invention provides viable solutions for overcoming these technological and economic issues by offering a suite of software and hardware modules designed to deliver media content to broadband Internet users and Intranet systems using an on-demand streaming media delivery approach.

One of the basic issues in dealing with digital video recording solutions includes the lack of information within the media file. The failure to have the ability to categorize a media file means that the time required to research a given incident/event or point in time is enormous. This issue climbs in exponential measurements as the number of media objects increases. The present invention provides the ability to categorize a media file using three different methods. The first method includes writing the content categorization in a specified format so that the operating system can use this information in the file properties. The advantage of this method can be demonstrated by viewing the file content at the operating system level as shown in FIG. 3.

Notice that the content information is shown in two different manners. The first manner is demonstrated by the file detail in the file list window shown on the lower left panel. This window shows the file name, its type, its date of last modification, size and content creator. The second is shown in the opaque banner which appears while hovering over the file in the file list window.

A second method in which the present invention categorizes the media information is through embedding this and other information directly within the media file itself. The advantage of doing this is primarily so that the media file may be delivered over a widely distributed environment and still remains categorized and searchable.

A third method employed by the present invention to categorize important media information is attributed to storing an abundance of this data within a database. The technology can store this information using a sophisticated and transparent layer of database protocols.

Another issue in dealing with digital video is the inability to find and view media files/segments at points of particular interest. At this time, even given the advantages of the digital video recorder, individual researchers are required to spend hours reviewing media content based on the time and date a media file was created when searching for a particular incident in time. For example, during an interview, a corporate human resource representative is required to review a particular candidate response at a given point in time. For the human resource representative to perform this task, they must know the name of the media file, where it is located, the time/date of the interview and where in the media file was the particular response given by the candidate.

The present invention employs advanced search and retrieval techniques to simplify this task. In order to retrieve a particular incident or event within a media file, the researcher is only required to specify simple keywords to a search engine which locates the media file and advances the playback position to the event point in the file which is important to the researcher/reviewer (i.e., a particular question asked in a meeting or interview). To achieve this, the technology embeds event tags deep within the media file at specific user-defined points during the encoding process in order to allow the researcher the ability to retrieve information within a given time segment. The media tags are connected to exacting frame locations within a given time segment. The researcher can then play the media file back at this or other points in the media file's timeline.

In employing these techniques as well as the content categorization, the present invention plays a very important role in the enterprise media library solution.

Content ownership, especially having to do with human resources, corporate meetings, medical procedures, depositions, law enforcement and video surveillance, is extremely important. The present invention also includes secure digital key functions to achieve content security for all media files distributed using the media server. Validated reviewers will have the required keys available to retrieve and view the content. In addition to this secure process, the present invention employs digital content tracking at the network and file level. Since the digital key functions can be integrated into the video server, it ensures that only authorized viewers will gain access to the media content. The user security level includes full-bit encryption; all user transactions and data are fully protected.

Additionally, there are several levels of defense employed against attacks to the validity of the embedded content. The first level of defense is the network login. This will keep people out of the system who don't have the authority. This network login should be changed frequently. The second level of defense is the access privileges given to particular user groups at the directory access level. Users without the proper access privileges cannot open the directory locations to the video files. The third level of defense is the file access privileges. Users without the proper authority will not be able to change a file. Others may not have the authority to view the file or copy it. The fourth level of defense is the file itself The media files are shrouded in a binary format which is unreadable by people. Only through special software may a person view and/or edit a media tag within a media file or its searchable content. The user identity of the person which last made a change as well as the date and time of the change is stored with the file and is viewable by anyone who has the proper access to the information.

Broadband connections are still not completely reliable. Connections go down, network servers go down and speed fluctuates, depending on network traffic and shared resources. In addition, the quality of current streaming technologies is seriously degraded under poor network conditions, providing the user with an inconsistent experience (at best). The present invention has been built on a very high level of reliability based on well developed network protocols. Media files are exchanged between the clients in a peer-to-peer model or between the client and server in a client/server model. The protocol used in delivering the media content is based on the use of media atoms. These are buffered based on network conditions and availability until the content can be retrieved for the most acceptable streaming experience possible at the chosen bandwidth.

The present invention is capable of being deployed on standard hardware and does not require high-end hardware components. This allows multiple systems to be deployed at different locations at a lower cost than the purchase of most single proprietary systems. In addition, because the software achieves fault tolerance, the hosting provider does not have to deploy complex high availability systems.

Many networked applications such as electronic commerce, distance learning, digital libraries, multimedia teleconferencing and online entertainment involve real-time delivery of stored media to a large number of clients across a heterogeneous inter-network. For continuous playback at the client, quality-of-service (QoS) must be provided in an end-to-end manner. The design of efficient large-scale media delivery systems can be complicated by such challenging issues as the highly bursty variable-bit-rate compressed video, the underlying heterogeneous networking environments, disparate client capabilities, and diverse client QoS requirements. Solutions addressing these issues must be both efficient and scalable.

While the present invention focuses on the ability to embed important information within the media file and supporting databases, it must deliver this information over a wide variety of client architectures. The system has several components which may be utilized to supply the business with its initial needs as well as grow with the business for needs at the enterprise level. Components used in the architecture behind the present invention include one or more encoding stations, local and remote search tools, data storage services, one or more cameras, one or more streaming media servers, and one or more web servers. Several configurations exist for the solutions described to achieve the balance between the business requirements and cost.

The present invention is expandable from a single system to a full-scale enterprise solution. This document discloses 7 levels of architectural designs based on the number of units and the needed distributed services.

An entry level option, Level 1, is the most basic system configuration is simply the encoding station. This system is capable of encoding media files, embedding event content and custom data within the media stream and storing the information to the system one or more hard drives. The Level 1 option is shown in FIG. 1.

The Level 2 option offers additional tools which may be used with the Level 1 configuration. These are the search module and data store which help locate media files and play them back using simple search strings or more advanced Boolean searches. The Level 2 option is shown in FIG. 2.

The Level 3 option offers the flexibility in having one or more Level 1 configurations connected in a peer-to-peer model where a designated station is the media aggregation point. In the example configuration shown in FIG. 6, the last station has been set as the designated media storage client. Here, each of the encoding stations will capture and deliver the media to this designated client as well as update the custom content and event tag information in the data store which resides on this fifth unit. The search analysis tool will be configured to read information from this machine for all five workstations when viewing stored media content. For the purpose of supporting a distributed remote search and a secure streaming media service, this last client in the given example may also be configured as a web server for the search, as a media server as well as be configured for secure key management. This configuration presents the lowest costing alternative while enabling a large number of the features which the system configuration enables in the larger business models. The obvious drawback to this architecture is that the fifth system is burdened with the unequal tasks of capture and media distribution from all of the other capture workstations.

The Level 4 service configuration offers a true client/server configuration where the encoding functionality is separated from the true storage and retrieval of the media content. In the given example, shown in FIG. 5, the five encoding stations have been given the sole tasks of media capture/creation while separate servers have been tasked with storage, search and retrieval. This search and retrieval may be performed as a local search function or a remote search function where software is not required to be loaded on the client and the reviewer/researcher has the flexibility of retrieving and viewing media content from anywhere inside or outside the facility over a network connection. In addition, as in the above configurations, the secure key configuration may be added for additional security to the media server.

The Level 5 configuration offers an additional quality-of-service factor in that the client/server architecture contains a backup server. This backup server serves as a mirror so that, in the case that the main server is out of service, the backup server takes its place for media storage, search and retrieval. This configuration minimizes downtime so that work may continue while the original server is being repaired and placed back into service. An expansion on the prior example is described in FIG. 6 by demonstrating the placement of the networked mirror.

The Level 6 configuration offers an added performance value where one or more encoding units are networked with a server cluster where the data store is separated from the media and web server. This configuration also offers an additional level of security for the database content. With the data store separated from the media server, the media delivery quality-of-service is heightened so that transactions between the client stations (both capture transactions as well as search and retrieval transactions) are isolated from the media delivery.

The final example configuration discussed in this document is the Level 7 configuration option. Although many other configurations as possible, this particular format demonstrates the true entry-level enterprise solution. Here the database server, the web server and the media streaming and distribution server are decoupled as to provide the most efficient performance available. In this configuration, search transactions from the web server are separated from data store transactions from the encoding systems. Furthermore, media delivery functions may be separated from the web services as well as data store transaction services.

In addition to this configuration, the secure key management processes may be moved to another server as well as providing physical “live” mirrors for each functional server. Various storage methods as well as integrated backup processes should be explored. In this given example, two process paths may be demonstrated. The first path involves the media capture scenario. Once a media file has been captured on the client, the file is placed on the media server. Custom attributes are then pushed from the capture client and stored in the database server for the media file as well as any event tag monikers. The second path is taken when a researcher decides to view a media file from the web search facility. The researcher inputs descriptive text in the search panel. The process communicates with the web server to build the appropriate search strings. The web server then communicates with the database server to build the result strings based on the embedded monikers and custom information found in the database. The result sets are delivered to the web client with links to the media files of interest to the researcher. Data store transactions have ceased at this point unless a new search is initiated. The researcher then chooses one of the media files to view. At this point, the secure key and media streaming servers negotiate bandwidth, authenticate the viewers' credentials, queue the video to the chosen moniker point, and deliver the content.

The present invention offers a comprehensive collection of interfaces which cover the enterprise requirements for media library aggregation from content creation to storage, search and retrieval. The systems involved provide administrative and normal user levels of configuration and usage. This document primarily discusses several tools available to the administrative user. The systems involved include the following list:

Data store schema generation

Administrative toolsets

Scheduling

Encoding

Searching

For systems which include the complete search and retrieval modules available for the system, the data store schema generation is used by the administrative user to create the base storage layout within a data store. The system of tables provides the storage persistence and searchable aspects. The option to leverage existing data also provided. This requires more involved data storage mechanisms without the loss of data. This tool may also be used to clear the current data store of existing data for the purposes of beginning with a clean slate, if desired.

The present invention contains a varied list of configurable settings which include media delivery options, data storage settings, external application settings, interface customization options, hardware interface settings and an editable list of the current users and administrators. The administrative editor uses a low-level system of messages so that changes to the system are distinguished immediately and used by the various system components without the need to save and refresh system processes.

The media delivery options (FIG. 7) include the ability to change the destination path which is used to store the media files once they are saved by the system. In addition to the destination path, the archive path may also be changed. This path is used to set the location used to store older media files once the main online system becomes close to capacity. The media streaming settings may also be selected in this section of the administrative editor.

The data storage section of the administrative editor allows the user to configure the data storage name and location. The system also supports unattended data refresh modes as well as XML data delivery. The external application settings section allows the user to modify the player path, the media recorder drive, the media recording application and the default media recording type. The interface options section allows the user to select certain modes available for the graphical user interface. One of these options includes turning on/off the background interoperable process used by the system. Without this process selected, scheduled and unattended sessions are not enabled as well as session restarts. Other interface options include the ability for the administrator to prevent the users from changing the title of the media file, to set the media title, to turn on/off the audio level indicator as well as set the maximum length of the media file name as well as other options.

The hardware interface section provides information for wireless or directly connected hardware controllers for the purpose of sending commands to a receiving system which operates the encoding session including start, stop, pause and mark activities. These commands are delivered to the system in a remote fashion so that the user recording the event is not required to be located at the computer. An example of this is shown in FIG. 10.

Lastly, the administrative editor provides a list of the current users. Administrative users have the ability to modify certain restrictions, schedule unattended sessions, set up external databases, delete media files, record files to external media, as well as modify many settings within the system. The users also have varying levels of permissions and control capabilities decided by the administrator as well as access privileges to cameras and rooms as well as the media data resulting from the associated recording sessions.

The scheduling component provides the ability to set, store, change and remove multiple schedule settings for unattended encoding and marking sessions. The encoders will start and stop without further intervention from the operator. Scheduling modes include daily, weekly, monthly, weekdays and one time.

The encoding component may be started either through a scheduled unattended event, an automated attended command, a hardware command, or by a manual start. Once the system starts, it diagnoses the available space for encoding files. If the space is limited the application presents a warning message, to let the user know that either files must be cleared out of the destination directory or the destination must be changed to another drive or network location.

The burn media option is an extremely innovative aspect of the current invention. Normally, files must be stored and burned on a local machine to be transferred to an optical media storage disk. The present invention provides the ability to distribute files from a media server to the operator's local machine and produce an optical disk from a remote location. FIG. 8 describes how this process is achieved. The innovation in this includes the ability to circumvent the usual security issues where files cannot be placed from a web server to a local web client without special permissions and the ability to write and control a local optical drive from a web server.

The search capability of the current invention provides the user with the ability to view a list of media files which have been recorded with relevant descriptive content. The data store and media file meta information are searched so that a resulting list is presented to the user based on the search criteria they used.

Once the user has located the media file they intend to review, they further have the ability to watch only a segment of the file or the full file in its entirety, based on their available time or interest level.

The author data setup panel, controls the major content information and activities on the encoder. The file summary panel contains text fields for the media title, author, copyright, notes, etc. This data is further embedded in the media stream and forms a searchable as well as mobile system for maintaining the defining characteristics of the present invention.

The meeting data panel in the setup interface (FIG. 9) provides the user with the ability to add, change, and delete the custom fields which are shown on the file summary information panel previously shown. In this interface, the field name, field data, field data mask, event data settings and drop-down details may be set. The field name is the name that is shown in the media file and on the left-hand side of the file summary information panel. If a field is set to static, the field data area allows the user to enter this data and it appears as the data entered in the media file for the given field name. The field data mask allows the user to specify the type of data which can be entered in a field and the number of characters the field is limited to, if desired. The event data settings allow the user to specify whether or not the field information is required, in which the user must enter data into the field during setup mode, static, where the user is not required or able to enter information, and neither where the field is open. The field types can be edit texts, drop-downs or timestamps. If the edit text type is chosen, the resulting control will simply be a free-entry text field. If the drop-down type is selected, the user will have the opportunity to select the drop-down details in that selection area. The drop-down details area allows a manually-edited drop-down list, or allows the user to specify a custom table name and column name for the drop-down data given the custom data set name which appears in the editor settings panel.

The event marker names panel, allows the user the ability to add, edit and delete marker titles. These marker titles show up in the media file and are able to be searched by using the search tool module. Once the marker button has been selected, the marker panel is shown. The user has the ability to enter information into the marker panel or select items in the drop-down boxes, depending on how the marker panel has been configured. Example markers could be editable text fields, drop-down selection lists or time and date stamps.

Once the entries have been added to the media file using the marker panel, they are added to the media file and the data store so they can be searched upon at a later time. Markers may also be added to the media and data store without the user being required to enter the marker details. If this is done, the marker titles are generated either from an existing list or from information based on the time the marker was selected.

Once the markers have been stored in the media file, not only can they be searched upon, but the media playback may begin at any of these markers so that the viewer can advance to a marked location, including a location they previously searched upon.

Once the encoding process has been stopped the media file is saved, its custom content, searchable content is saved, the marker data is stored, and the file is delivered to the server with the appropriate access permissions applied.

To begin a search for a media file of interest, the user navigates to the search panel and enters text in the search control and presses a button to begin the search. The search routine will take the content of the search control and compare the one or more strings with the strings found in the media files and the data store. If comparisons result in one or more matches, the one or more resulting media file links are displayed with the associated custom data and marker text, if supplied. Once a media file has been selected, it can either be played in whole, in part, using the slider or one of more markers, it can be segmented, downloaded, burned to optical media, edited, or deleted. Editing an existing media file provides the ability to add, remove or change markers, descriptions, custom fields, etc.

The resulting presentation output can be delivered by the system as shown in FIG. 11 where a media output is placed in a section of the screen, synchronized with a set of slides. The user has control of what is seen at what time by either sliding the progress bar forward or backward in time or by selecting the time segment, marker, or slide they wish to view. The presentation is further enhanced by loading web pages or advertisements by using embedded markers or URLs in the media file and showing them in relationship to the media playback. The timeline bar can also present alternative media links from the system which can be played back to a receiving audience in a broadcast scenario.

Additionally, the present invention provides support for receiving one or more media files as external input, not requiring the camera and/or microphone as shown in FIG. 4. The file input then can be in turn, converted to the correct media format, segments may be removed, added, etc as well as providing the custom field information, markers, and custom content, such as links, web sites and advertisements.

The resulting presentation output can be delivered by the system as shown in FIG. 11 where a media output is placed in a section of the screen, synchronized with a set of slides. The user has control of what is seen at what moment in time by either sliding the progress bar forward or backward in time or by selecting the time segment, marker, or presentation slide they wish to view.

Further, the presentation slides could also be web pages showing additional detail or advertisements regarding the information the user chose to view the presentation. In this manner, the advertisement is focused on some targeted aspect which interests the viewer.

Still further, the prior presentation could be delivered as a broadcast to a group of viewers in remote locations while the conference is being held in a live format. The person controlling the present view could select a prior presentation to play back in a broadcast manner shown in FIG. 12.

At this point, the major processes from the content configuration and creation to search and retrieval have been discussed. This document has provided an overview of the necessary settings used to deliver media to one or more points of destination, play the media back and perform search functions on the media library. The present invention offers a diverse and truly scalable model for the business in the field of digital video recording and management. The advantages of the current invention over existing systems can be seen in quality, usability improvements, ease of distribution, security, as well as the ability to perform queries for near-instantaneous content retrieval at the particular moment of interest thus reducing costs and delay associated with existing tape-based systems as well as other digital video recorders. Several cost and technological issues plaguing current surveillance solutions such as content categorization, content search/retrieval, content security, network and storage reliability, cost of management, and system scalability have been solved using the present invention.

In addition to using the camera and other connected equipment for video and/or audio capture, some externally connected equipment, as shown in FIG. 13, may be used to provide additional data which may be synchronized to the captured video/audio streams. For example, one or more thermal detectors can be used to record temperature readings and send these readings back to the one or more encoding units. This temperature records could then be added to the media file or data store using the timestamp based on the recording duration of the media file and could be later searched upon and/or displayed as the media file is played back. For example, if a user wanted to search for a temperature in the recording where the temperature was above 95 degrees, the search result could show the segments of the media file where the temperature was equal to or greater than the queried 95 degrees.

Likewise, equipment may be used to provide additional data which may be synchronized to the captured video/audio streams related to motion, as shown in FIG. 13, in one or more particular areas of the media capture or the entire picture. For example, one or more motion detectors, either connected as part of the camera or externally, can be used to record motion and send these readings back to the one or more encoding units. This motion records could then be added to the media file or data store using the timestamp based on the recording duration of the media file and could be later searched upon and/or displayed as the media file is played back. For example, if a user wanted to search for one or more motion readings in the recording where the motion took place either at a particular percentage of time or a particular percentage of the camera view, the search result could show the segments of the media file where the motion readings satisfied the query. In this event, the user would only see the information they were interested in and could adjust their search to find more information if needed, or watch the media file in its entirety.

In addition, equipment may be used to provide additional data which may be synchronized to the captured video/audio streams related to object detection, as shown in FIG. 13, in one or more particular areas of the media capture or the entire picture. For example, one or more object detectors, either connected as part of the camera or externally, can be used to record and recognize one or more objects during the media capture and send these readings back to the one or more encoding units. This object detection records could then be added to the media file or data store using the timestamp based on the recording duration of the media file and could be later searched upon and/or displayed as the media file is played back. For example, if a user wanted to search for one or more object detection readings in the recording where the object they were interested in was a person either over a particular amount of time or a particular percentage of the camera view, the search result could show the segments of the media file where the object detector readings satisfied the query by locating a person in the video area of interest. In this event, the user would only see the information they were interested in and could adjust their search to find more information if needed, or watch the media file in its entirety.

### BRIEF DESCRIPTION OF THE DRAWINGS

FIG. 1 is a example configuration of a distributed system of the present invention.

FIG. 2 is another example configuration where the system described has one or more web client applications which send and receive information to/from one or more encoders which have access to one or more cameras and/or microphones.

FIG. 3 shows the architecture of the file structure for the present invention.

FIG. 4 describes a feature of the present invention where an unconverted media file or files may be delivered from the web client to the encoding service and compressed as well as having the ability to inject the custom fields, markers and other searchable content.

FIG. 5 describes another example configuration of the present invention capture and searchable stamping process.

FIG. 6 describes yet another example configuration of the present invention where an attached mirrored storage solution has been added for additional flexibility in providing media redundancy.

FIG. 7 describes an example configuration in the present invention where settings to a primary storage are made.

FIG. 8 describes another innovation of the present invention where files are placed into packages on a remote server by commands delivered on the client web page.

FIG. 9 shows the meeting data panel in the setup interface which provides the ability to add, change, and delete the custom fields which are part of the file summary information panel.

FIG. 10 shows the command flow for the hardware interface for wireless or directly connected hardware controllers.

FIG. 11 shows an example presentation format which includes a slideshow, video, audio, web pages synchronized with the video/audio track, as well as marker links, captions, media information, a media chronological controller and associated advertising content.

FIG. 12 shows an additional form of the presentation capability where a camera is capturing a live event and the presentation spokesperson is delivering through a broadcast of another presentation to group of viewers as they describe the pre-recorded presentation in the current presentation.

FIG. 13 shows another example of the instant invention having one or more alternative input devices.

### DETAILED DESCRIPTION OF THE INVENTION

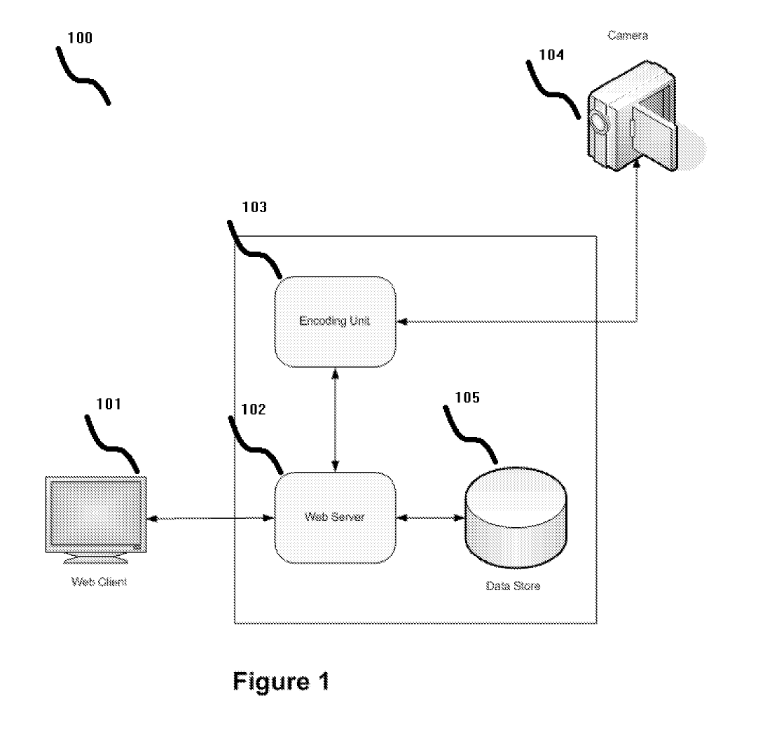

Referring now to FIG. 1, a distributed system 100 configuration of the instant invention is shown. The system 100 can also be completely self-contained on one computing device, chip, or other storage device. The system 100 communicates from the computing device, for example, with the camera 104 through a series of one or more commands. This communication can include starting a recording session, pausing a recording session, stopping a recording session, as well as other possible commands.

The commands are in the form of voltage interrupts, text strings or binary segments which follow a known pattern decipherable by the receiving entity. The one or more commands could come from one or more connected devices as shown in system 100, one or more remote devices, not shown, as well as other devices which are not necessarily computing devices, such as handheld infrared, USB, Bluetooth, etc. controllers, among other possible devices.

The computing device or controller may also have the ability to include additional information and commands which are used to enhance the media data received from the camera 104 or the encoding unit 103.

One or more commands may be instantiated from the web client 101 and is sent from the web client 101 to the web server 102, receiving the command, converting the command to a message, sending the message to an encoding unit 103, the message received from the web server 102 by the encoding unit 103, sending the message to the camera 104, the camera 104 receiving the message from the encoding unit 103, the camera 104 turning on, turning off, zooming, changing focus, moving, or some other action. If the camera 104 is recording, the camera 104 sends video and/or audio, the media data, from the camera 104 to the encoding unit 103. The encoding unit 103 can also be a part of the camera 104 where the encoding unit 103 simply injects the ancillary information into the media data. The media data received by the encoding unit 103, the media data further encoded by the encoding unit 103 with additional descriptive data from the web server 102. The web server 102 storing the media data and descriptive data to the data store 105, further sending a response from the web server 102 to the web client 101 which acknowledges the command sent from the web client 101 to the web server 102.

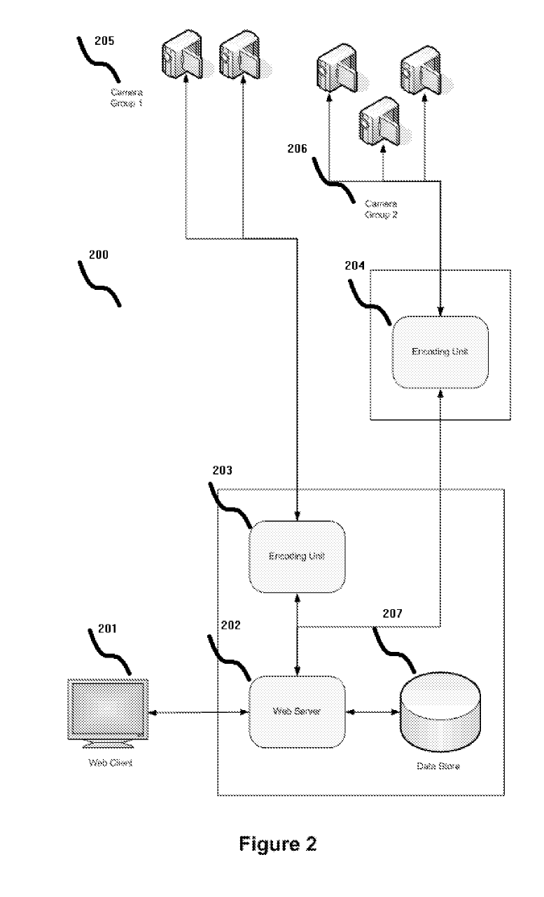

Referring now to FIG. 2, a widely distributed system 200 configuration of the instant invention is shown. The system 200 communicates from the computing device, for example, with the one or more camera groups 205 and 206 through a series of one or more commands. This communication can include starting a recording session, pausing a recording session, stopping a recording session, as well as other possible commands.

The system 200 further depicts the capability of the instant invention which has the ability to communicate from one or more web clients with groups of one or more encoders which further communicate with groups or one or more cameras.

These camera groups can be assigned to particular locations. For example, a group of cameras may be assigned to a room. Once the encoder message is received from the web server, the cameras in that given group can be all turned on at the same time and further controlled. The cameras in a group can also be assigned to a floor, one or more rooms, an area, etc.

The description following concentrates on an example where the cameras in each of the camera groups 205 and 206 receive the same commands at the same time. However, each camera group may be sent commands independently. Therefore, it is not necessary to assume that all camera groups receive the same one or more messages.

One or more commands may be instantiated from the web client 201 and is sent from the web client 201 to the web server 202, receiving the command, converting the command to a message, sending the message to an encoding unit 203, the message received from the web server 202 by the encoding unit 203, sending the message to each of the cameras in the camera group 205 and camera group 206, the camera group 205 and camera group 206 receiving the message from the encoding unit 203, the camera group 205 and group 206 turning on, turning off, zooming, changing focus, moving, or some other action. If the camera group 205 and camera group 206 are recording, the camera group 205 and camera group 206 send video and/or audio, the media data, from the camera group 205 and camera group 206 to the encoding unit 203 or the encoding unit 204. The encoding unit 203 or the encoding unit 204 can also be a part of the camera group 205 and camera group 206 where the encoding unit 203 and encoding unit 204 simply inject the ancillary information into the media data. The media data received by the encoding unit 203 and encoding unit 204, the media data further encoded by the encoding unit 203 and encoding unit 204 with additional descriptive data from the web server 202. The web server 202 storing the media data and descriptive data to the data store 207, further sending a response from the web server 202 to the web client 201 which acknowledges the command sent from the web client 201 to the web server 202.

The web client 201 further having the ability to send one or more commands to the web server 202, the web server 202 sending the one or more commands to the data store 207, the data store 207 sending the media data requested to the web server 202, received by the web server 202, send to the web client 201, received by the web client 201 and processed by the web client 201 or other entity.

The web client 201 further having the ability to perform a search, the search receiving a list of media data links which correspond to matches found using the string content making up the search. The list of media data links being accessed from the web client 201, the web client 201 sending one or more requests for the one or more media data from the web client 201 to the web server 202, the web server 202 receiving the one or more requests, the web server 202 sending the one or more requests for the one or more media data to the data store 207, the data store 207 receiving the one or more requests and sending the one or more media data to the web server 202. Further the web server 202 receives the one or more media data and sending the one or more media data to the web client 201, the web client 201 receiving the one or more media data, accessing the one or more media data in the manner requested.

The web client 201 further processing the received media data by one or more actions. These actions could include playing the media data, forwarding through the media data, editing the media data, deleting the media data, storing the media data to one or more optical drives or other storage media, as well as other possible actions based on the permissions of the user on the web client 201.

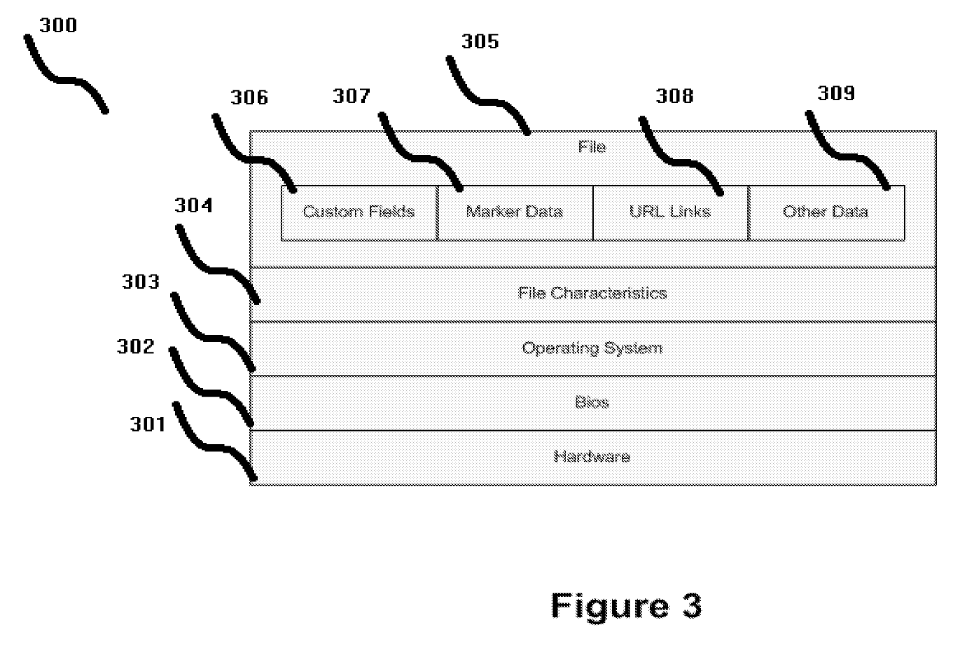

Referring now to FIG. 3, the architecture of the file structure 300 used in the instant invention is shown. The file format sits on the operating system 303 which interfaces with the system bios 302 and hardware 301. The file characteristics 304 contains the file make-up and structure, byte positioning, etc. which is used by the operating system to read the file 300. The contents of the file are described in the file content 305. The file content 305 has the custom fields 306, the marker data 307, universal resource links (URL) 308 as well as other data 309.

The file content 305 and file characteristics 304 are read by a software which runs on the operating system 303 so that the file can be processed. For example, if a file process to play the media data for the user, the software player, running on the operating system 303 reads the file content 305 and file characteristics 304, the contents of the file content 305 and file characteristics 304 received by the software program and playing the media data for the user.

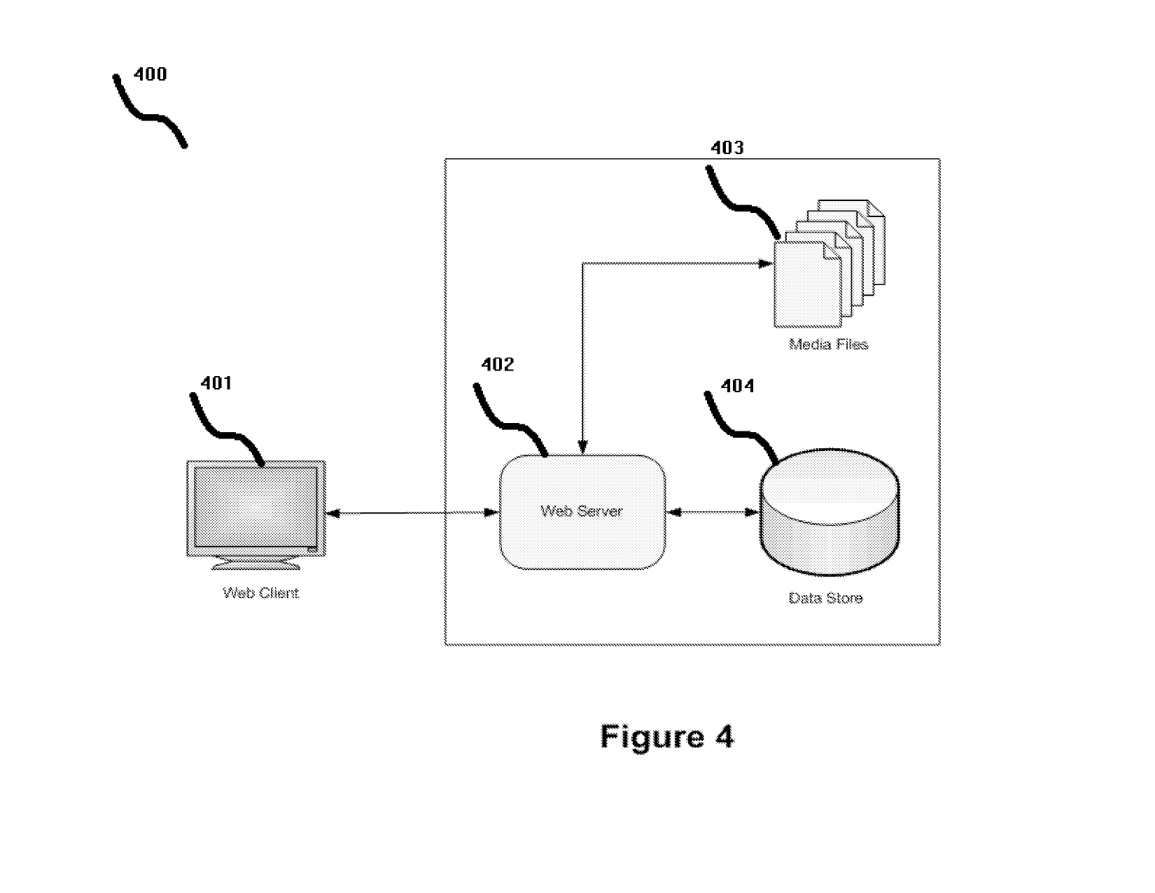

Referring now to FIG. 4, the present invention provides support for receiving one or more media files as external input, not requiring the camera and/or microphone as shown in system 400. The one or more files 403 received by the web server 402, being in a compressed or uncompressed format, is then converted to the target media format, dictated by the user on the web client 401. The converted media data received by the web client 401 for further processing and/or storage from the web server 402 to the data store 404. Converting the one or more media files 403 may include converting the file format of the video and/or audio portion of the file, but also can mean changing existing media descriptors, adding descriptors, and/or removing descriptors. These descriptors may include custom field information, markers, and custom content, such as links, web sites and advertisements as well as other items. These converted entities may also include the addition, removal, replacement and/or changing portions or segments of the media data.

Once the user has finished modifying the media files 403 into a converted series of one or more files, they may be stored to the data store 404 by the web client 401 sending a command to the web server 402, the web server 402 storing the modified one or more media data to the data store 404.

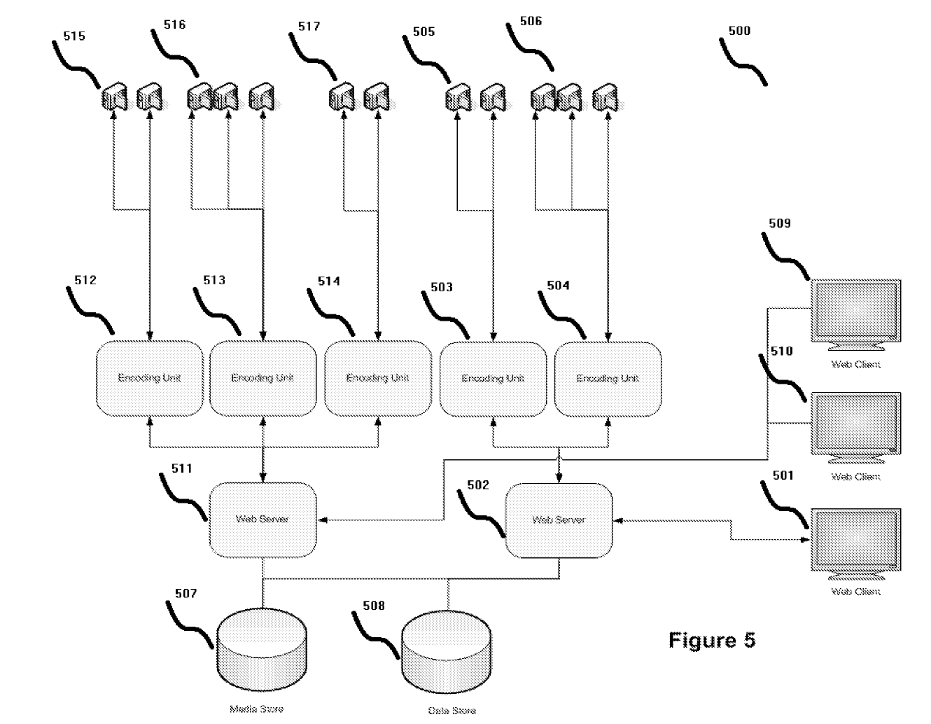

The data store 404 may also be used to store tables and records related to the media descriptions while the media data exists on the web server 402 and is not transferred to the data store 404. However, the media data may also be placed on an independent storage device, a media store, as further described in a system 500 in FIG. 5.

Referring now to FIG. 5, a system 500 describes another example configuration of the present invention capture and searchable stamping process where the encoding stations have been given the sole tasks of media capture/and content creation while separate servers have been tasked with storage, search and retrieval.

For example, the web client 501 can send one or more commands to the web server 502, the web server 502 receiving the one or more commands and sending one or more commands to the encoding unit 503 and the encoding unit 504. The encoding unit 503 sending one or more commands to the camera group 505 and the encoding unit 504 sending one or more commands to the camera group 506. Both the encoding unit 503 and the encoding unit 504 receiving audio and/or video recorded streams and storing these streams to the media store 507.

In addition, the web client 510 can send one or more commands to the web server 511, the web server 511 receiving the one or more commands and sending one or more commands to the encoding unit 512, the encoding unit 513 and the encoding unit 514. The encoding unit 512 sending one or more commands to the camera group 515, the encoding unit 513 sending one or more commands to camera group 516, and the encoding unit 514 sending one or more commands to the camera group 517. The encoding unit 512, the encoding unit 513 and the encoding unit 514 receiving audio and/or video recorded streams and storing these streams to the media store 507.

The web client 509 receiving input from the user, the web client 509 sending the user input to the web server 511 which places the user input from the web server 511 into the data store 508. This user input may be custom data fields, marker data, URLs, or other data which can be time-synchronized to the media data being captured by encoding unit 512, 513, 514, 503 or 504. The user data can be applied to one of the media data stream received, some, or all based on the setup performed by the user. The user data may be stored in the data store 508 but can also, at least partially, be stored in the media data file stored in the media store 507.

In addition, any of the web clients 509, 510, or 501 may send one or more commands to their respective web servers 511 or 502 and communicate with the data store 508, as in performing a search or editing saved information pertaining to any of the media data files, or communicate with the media store 507 by making one or more requests to view, edit, download, burn, etc. the media data from the media store 507.

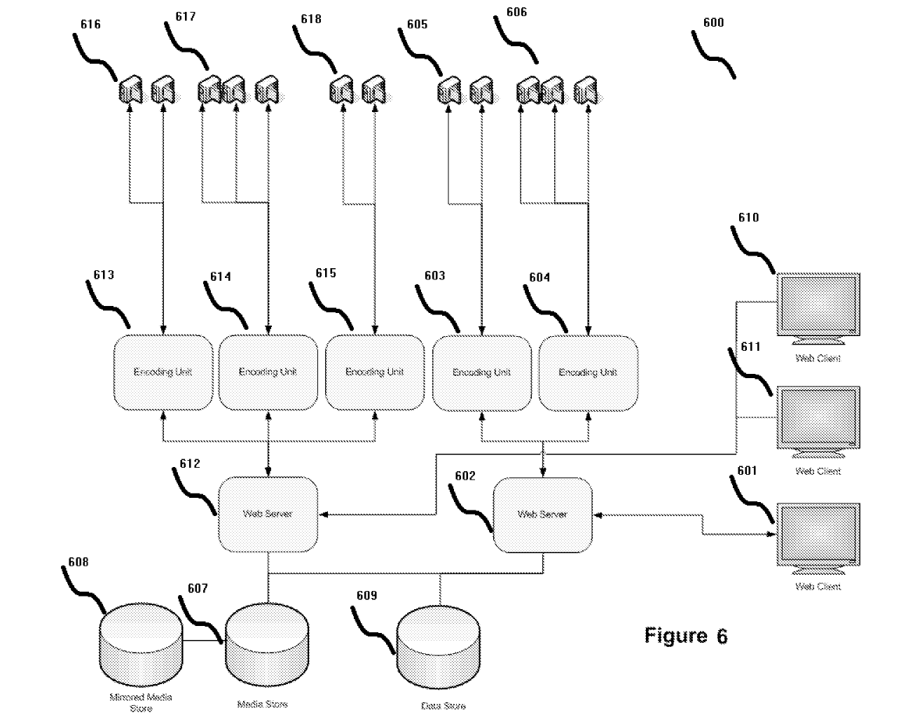

Referring now to FIG. 6, a system 600 describes another example configuration of the present invention capture and searchable stamping process where the encoding stations have been given the sole tasks of media capture/and content creation while separate servers have been tasked with storage, search and retrieval with an attached mirrored storage solution for additional flexibility in providing media redundancy.

For example, the web client 601 can send one or more commands to the web server 602, the web server 602 receiving the one or more commands and sending one or more commands to the encoding unit 603 and the encoding unit 604. The encoding unit 603 sending one or more commands to the camera group 605 and the encoding unit 604 sending one or more commands to the camera group 606. Both the encoding unit 603 and the encoding unit 604 receiving audio and/or video recorded streams and storing these streams to the media store 607 and the mirrored media store 608 for redundancy purposes or for access through another network location, etc.

In addition, the web client 611 can send one or more commands to the web server 612, the web server 612 receiving the one or more commands and sending one or more commands to the encoding unit 613, the encoding unit 614 and the encoding unit 615. The encoding unit 613 sending one or more commands to the camera group 616, the encoding unit 614 sending one or more commands to camera group 617, and the encoding unit 615 sending one or more commands to the camera group 618. The encoding unit 613, the encoding unit 614 and the encoding unit 615 receiving audio and/or video recorded streams and storing these streams to the media store 607 and the mirrored media store 608 for redundancy purposes or for access through another network location, etc.

The web client 610 receiving input from the user, the web client 610 sending the user input to the web server 612 which places the user input from the web server 612 into the data store 609. This user input may be custom data fields, marker data, URLs, or other data which can be time-synchronized to the media data being captured by encoding unit 613, 614, 615, 603 or 604. The user data can be applied to one of the media data stream received, some, or all based on the setup performed by the user. The user data may be stored in the data store 609 but can also, at least partially, be stored in the media data file stored in the media store 607 or the mirrored media store 608.

In addition, any of the web clients 610, 611, or 601 may send one or more commands to their respective web servers 612 or 602 and communicate with the data store 609, as in performing a search or editing saved information pertaining to any of the media data files, or communicate with the media store 607 and the mirrored media store 608 by making one or more requests to view, edit, download, burn, etc. the media data from the media store 607 and/or the mirrored media store 608 without the user being required to know where the files are located.

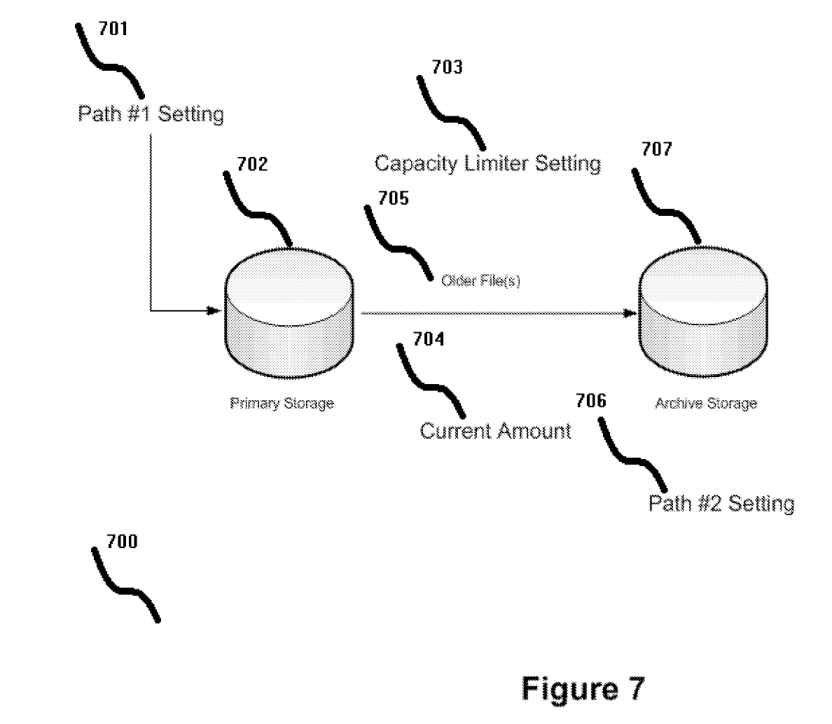

Now referring to FIG. 7, a media data archival configuration arrangement 700 is shown. Based on the user settings for the media delivery options, the primary path setting, the archival path setting and the capacity limiter are required to dictate the archival parameters. A date could also be used so that files which become equal to or older than a user-specified date are moved from the primary storage location to the archival storage location. Additional processing could take place based on capacity or date which rolls the archived data from the archival location to the trash or removed from the disk.

The primary path setting 701 is set to a local or remote disk location. If the capacity limiter 703 is selected by the user, either through an interface setting or programmatically, and the current disk storage size 704 in the primary storage 702 is equal to or exceeds the capacity limiter setting 703, then the oldest file 705 in the primary storage 702 is moved from the primary storage 702 to the archive storage 707 based on the archival path setting 706.

If the archival date setting is set by the user, either in a user interface or programmatically, and one or more files age equal to or older than the archival date setting, the one or more files are moved from the primary storage 702 to the archival storage 707.

Still, alternative methods could be used where the date and/or capacity limiter 703 could be used to set the archival window based on which one is reached first. For example, if the date is received before the capacity setting is met or exceeded, then the files would be moved based on the age of the one or more files. If the capacity limit has been reached, the one or more files are moved based on the capacity of the one or more media files.

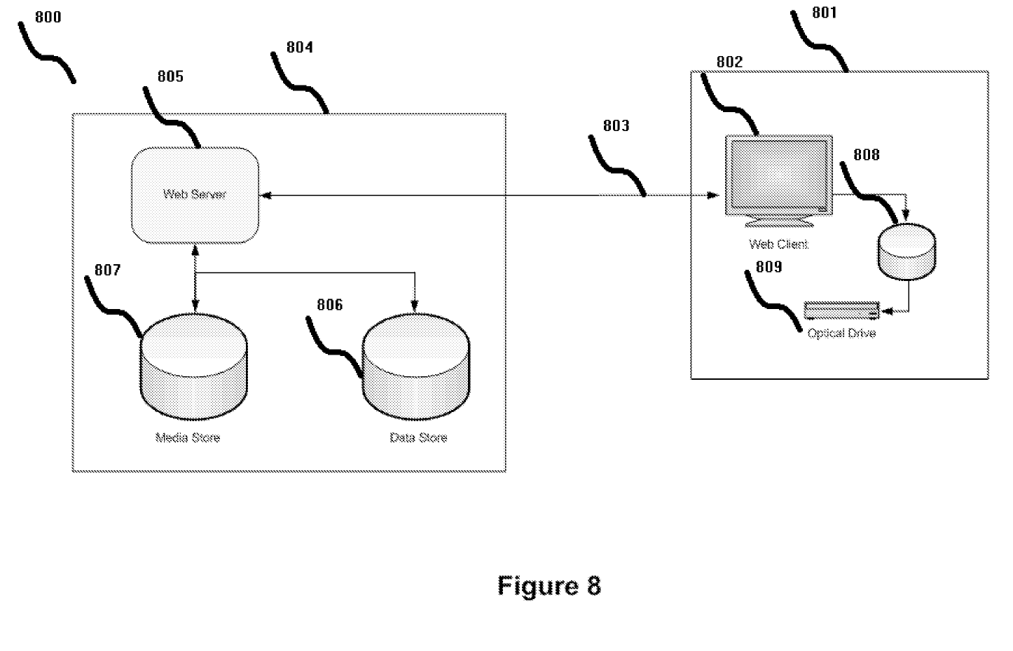

Referring to FIG. 8, a portion of the instant invention is shown relating to storage of one or more media files onto an optical or other storage device. Depicted in system 800 one or more media files may be written to a locally connected optical drive, but this could also be a remote optical drive or other device to which the media files are being written or copied.

Having the ability to communicate through a web client to a remotely attached optical drive is an important innovation of the instant invention due to the problems with performing this task in current systems which limit access to either the optical drive or files based on permissions and other file transfer issues. The instant invention removes these barriers by communicating with a web server which moves the requested files to the local machine before writing the one or more files to the disk mounted in the optical drive.

Therefore, in the example configuration depicted in the system 800, the client system 801, having a web client 802, a local drive 808, and an optical drive 809, makes one or more requests for one or more files from the web client 802 to the server 804 which has a web server 805, a media store 807 and/or a data store 806, the media store 807 and the data store 806 could be combined as one unit within the server 804.

Once the one or more requests for the one or more files are made by the web client 802 to the web server 805, the web server 805 receives the one or more commands from the web client 802, converting the one or more commands into one or more file requests of the one or more files located on the media store 807.

The web server 805 receives the one or more media files from the media store 807, transmitting the one or more media files to the web client 802 which stores the one or more received media files to the hard drive 808 on the client 801. The web client 802, checking to see that the files have completely arrived from the web server 805 to the hard disk 808, begins to burn the one or more media files to the optical drive 809 from the files stored on the hard disk 808.

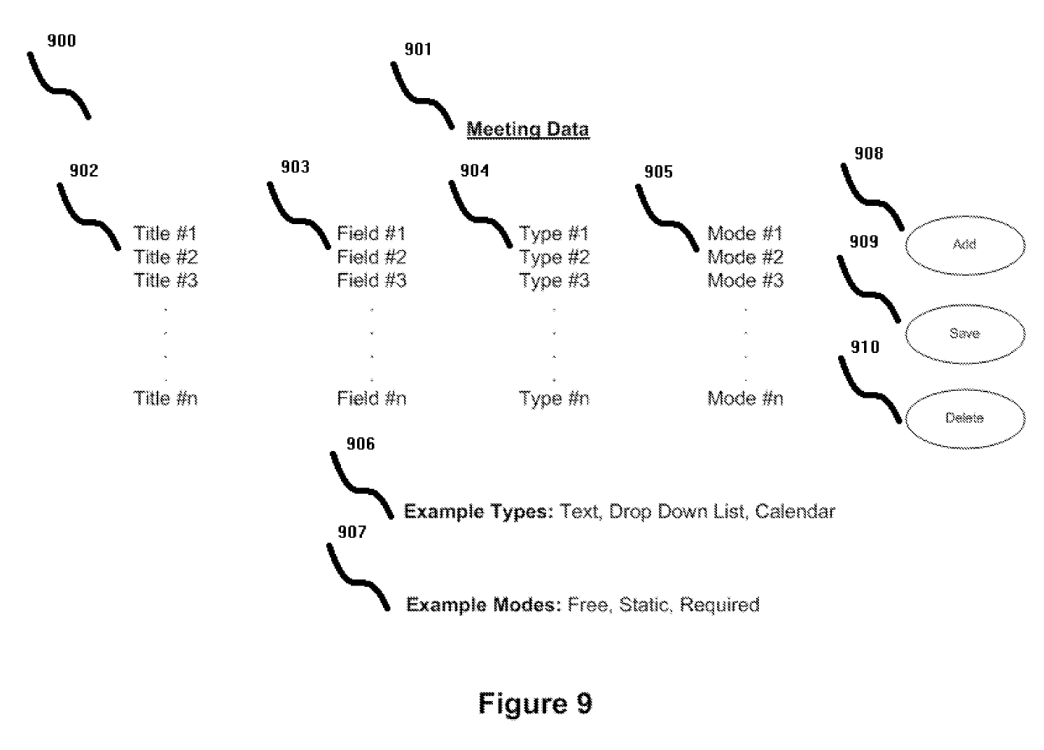

Referring now to FIG. 9, a portion of the instant invention is shown which depicts one or more custom fields available in the system 900. Custom fields, in the example case called meeting data 901, represent user-enterable data which describes the one or more recorded media files. The custom fields can be entered before, during or after the one or more media files have been recorded and may be changed at a later point in time based on the permissions granted to the particular user. The custom fields are represented using titles, fields, field types and field modes. In addition, any number of custom fields may be associated with the one or more media files.

For example, a media file may have a custom field title #1 902 called “Speaker Name”. This entry prompt might appear before the media file is to be recorded and can be filled in by the user. Associated with the same media file, another Title #2 902 could be “Speaker Location”. This entry prompt could also appear with the first title #1 902 before the media file is recorded so that the field can be entered by the user.

In the current example, the field #1 903 could hold the speaker's name, corresponding to the title #1 902, and could have a field type #1 904 of text 906, which denotes the ability to enter text in the field. Other types 906 could include drop down, where multiple entries are selectable by the user without requiring the user to type input into the field, a calendar, and may include other field types 906. Likewise, the field mode 905 can be selected which can include field modes 907 such as a free field, a static field, which has the data pre-entered for the user and is not changeable by the user, or required where the user must enter or select something in the given field before they can record the media file, and may include others.

In addition to the ability for the user to enter and select the given configuration of the one or more custom fields, they may also have one or more options which include the ability to add 908 more fields or drop down list items, save the configuration 909, change the configuration, and/or delete a record 910 in the configuration.

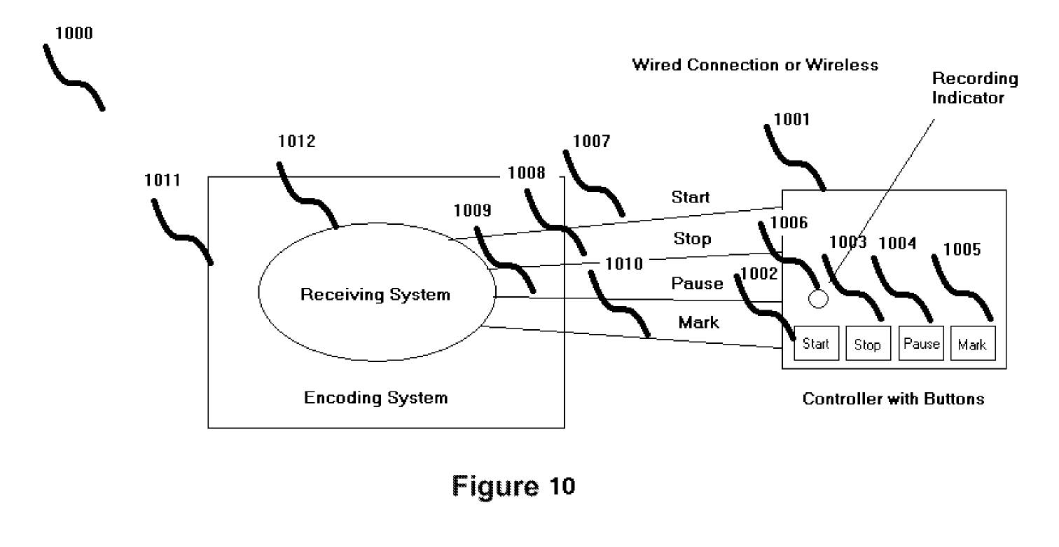

Referring now to FIG. 10, a portion of the instant invention 1000 where, in addition to scheduling a recording session, a manually controlled, physical communication unit is shown. The controller unit 1001 may be connected to the receiving system 1011 through a wired or wireless connection. The receiving system 1012 communicates and may reside with the encoding system 1011, with which the receiving system 1012 sends commands to the encoding system 1011 through message strings or other means for the purpose of controlling the recording session. The controller unit 1001 may communicate with the receiving systems 1012 through electrical impulses, command strings, interrupts, or other means which are receivable and decipherable by the receiving system 1012. A recording indicator 1006 may be used to indicate that a recording is being performed by appearing illuminated when the recording is under way and being turned off when the recording is not being performed. Different colors may also be used to indicate the recording session state, such as red for recording, yellow for pause and green for stop, indicating that the recording unit is available for use. The buttons on the face of the controller unit 1001 are used to control the recording session.

For example, the start button 1002, when activated, such as by pressing or voice activation, etc., sends a start message 1007 from the controller unit 1001 to the receiving system 1012. If the recorder is available, the receiving system 1012 sends a message to the encoding system 1011 to begin the recording session.

If the pause button 1004 is activated, such as by pressing or voice activation, etc., during a recording session, a message is sent for pause 1009 from the controller unit 1001 to the receiving system 1012 which then sends a message from the receiving system 1012 to the encoding system 1011 to pause the recording session. At the point when the pause message has been received by the encoding system 1011, the recording session is pause so that no additional media data is being recorded, but the recording session and corresponding media data file has not been closed.

If the pause button 1004 is activated again, such as by pressing or voice activation, etc., while in pause mode and during a recording session, a message is sent for pause 1009 from the controller unit 1001 to the receiving system 1012 which then sends a message from the receiving system 1012 to the encoding system 1011 to resume the recording session. At the point when the resume message has been received by the encoding system 1011, the recording session is resumed so that additional media data is recorded and appended to the corresponding media data file.

If the mark button 1005 is activated, such as by pressing or voice activation, etc., during a recording session, a message is sent to mark 1010 the instance in time from the controller unit 1001 to the receiving system 1012 which then sends a message from the receiving system 1012 to the encoding system 1011 to mark the recording session in time. At the point when the mark message has been received by the encoding system 1011, the recording session is marked. The mark is injected into the media data file or may be stored in the data store (not shown) so that it may be retrieved at a later time. The mark may also be stored in a regular file with the timestamp of the mark relative to the beginning timestamp of the recording session. Once the recording session has been stopped and the media data file is to be finalized, any marker data, either from the data store, text file or other means can be added into the media data file. In this manner, search string can be associated with the marker so that searches can locate the strings by a match and provide the marker links to a user who may be interested in the particular portion of the media file at that point in the playback.

If the stop button 1003 is activated, such as by pressing or voice activation, etc., during a recording session, a message is sent for stop 1008 from the controller unit 1001 to the receiving system 1012 which then sends a message from the receiving system 1012 to the encoding system 1011 to stop the recording session. At the point when the stop message has been received by the encoding system 1011, the recording session is stopped so that no additional media data is being recorded and the recording session and corresponding media data file are closed. At this point, any additional information may be added to the media data file which may provide the ability to search for the media data file and/or markers within the media data file or other information, such as URLs, advertisements, slide show images, associated web pages, and custom fields, meeting data, etc. In addition, the media data file may be edited using the capabilities of the instant invention. The file may be changed by removing or inserting additional media data as well as altering, adding and/or removing custom fields, markers, etc.

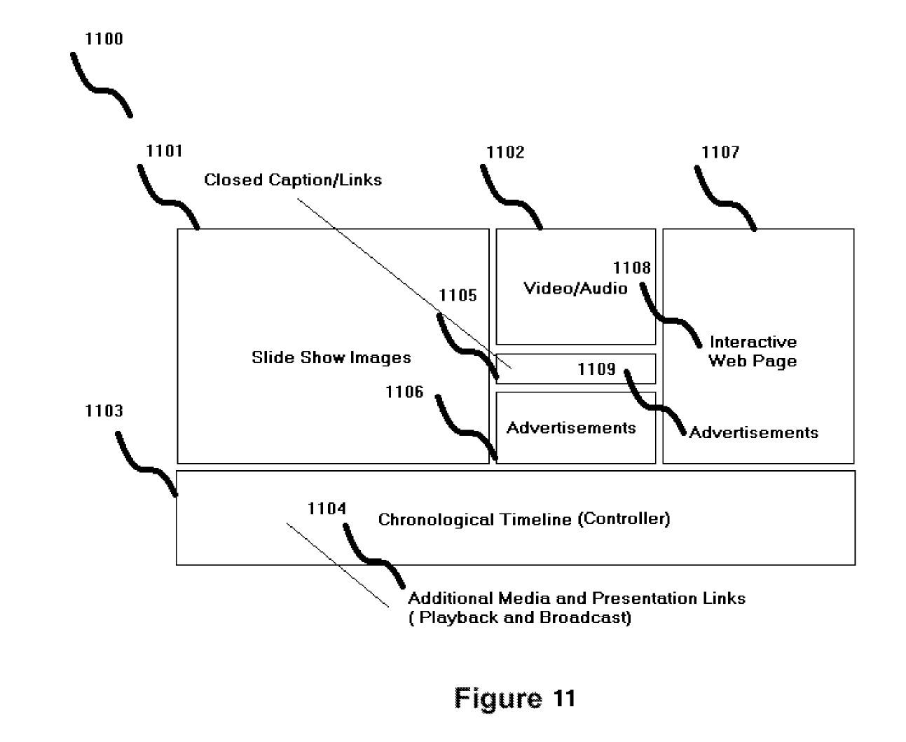

Referring now to FIG. 11, a portion to the instant invention is shown which shows an example playback arrangement 1100 of the media data file 1102, showing some of the additional media data associated with the media data file 1102.

The supporting elements of the media data playback may include slide show images 1101, close captions and/or links 1105, advertisements 1106, interactive web pages 1107, other advertisements 1109, additional media and presentation links 1104, as well as other possible video and/or audio playback, and other items not shown. Each of these elements may be independent but also can be controlled by the media file playback timeline. So that, if the user wishes to skip to an interesting portion of the media playback segment, the associated supporting elements, such as the slide show images 1101 and advertisements 1106 change in relationship to their association to the media data 1102 at the given point in time so that the media data 1102 is fully synchronized in time with the supporting elements on the page.

This synchronization is performed by having a master association file. The master association file is generated automatically by the system as the recording session takes place. When a mark button is pressed, for example, the information for the mark insertion is placed into the file and it builds as the recording session continues. This master association file may be built separately by another application or an editor and associated with the recording as described. In this manner, items such as titles would be read from the master association file and inserted into the media data or other locations. The master association file is used at the time of playback and may be read from the data store or from the media data file 1102. Once the media data file playback timeline reads a pointer in the playback file which points to a new URL, for example, or other piece of supporting data, the URL is invoked which may present a web page 1107 or a slide show image 1101, or both. The same process could be performed for advertisements 1106 and closed captions 1105 as well as other information.

The media playback may be controlled by links 1105 to the marker points in the media data file 1102, controllers on the media data file 1102 interface, an external control device (not shown), or by a control timeline 1103. The control timeline 1103 may have thumbnail images associated with the marker points and/or pointers in the media data file 1102, hyperlinks, or other indicators which may be provided to the user. A scrollbar which moves the list of images or other information may be provided which allows the user to vertically or horizontally move the list of images or other information in a manner which presents the information the user is interested in seeing. Timeline numbers or other information may also be shown which makes it easier for the user to find the point in time they are interested in appear on the screen.

For example, the user may want to see a segment of the media presentation which is one hour into the timeline of the presentation and the presentation may be four hours long. The user would simply scroll to the right on the timeline controller 1103 to find the hour label or a thumbnail image of the presentation at the given point on interest and click on the image, link, or other information. Once the image, link, or other information has been clicked on, the media data file 1102 would advance its playback position pointer to the associated point in the timeline and begin the playback from this point. The corresponding slide show images 1101, web page 1107, and other items may change as directed by the synchronization master file associated inside of the media data file 1102.

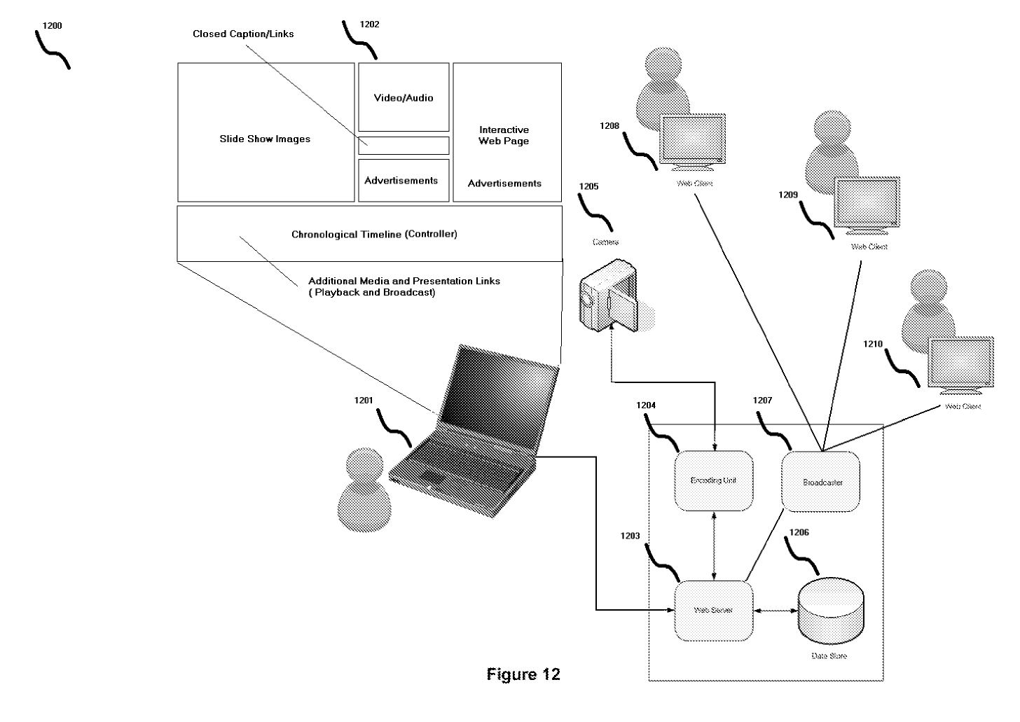

Referring now to FIG. 12, an example depiction of the instant invention is shown which includes the real-time encoding component attached to a camera and the playback of the recording session and captured supporting elements shown from FIG. 11 shown in a system 1200. Even though a single computing device is shown in the system 1200 as the encoding and broadcasting system, one or more computing devices may be involved as this is just an example.

The computing device 1201 may be logically connected to the instant invention which includes the encoding unit 1204, the web server 1203, the broadcaster 1207 and the data store 1206. Other items such as a media store may be included, but not shown in this example.

To record a presentation, the computing device 1201 or external control device may send a START message to begin a recording session from the computing device 1201 to the web server 1203, the web server 1203 receiving the message, the web server 1203 sending the message to the encoding unit 1204, the encoding unit 1204 receiving the message and sending a corresponding command from the encoding unit 1204 to the camera 1205. Once the camera 1205 receives the START command from the encoding unit 1204, the camera 1205 begins recording media data and sending the recorded data from the camera 1205 to the encoding unit 1204, the encoding unit storing the media data to the data store 1206. The data store 1206 may also receive one or more slide show or screen capture images or other data associated with the presentation from the web server 1203 as the supporting elements. Once the supporting elements are received by the data store 1206, they may be displayed with the media data file using the broadcaster 1207 to the one or more web clients 1208, 1209, and 1210.

To mark a timeline pointer in the presentation, the computing device 1201 or external control device may send a MARK message to mark a recording session from the computing device 1201 to the web server 1203, the web server 1203 receiving the message, the web server 1203 sending the message to the encoding unit 1204, the encoding unit 1204 receiving the message and sending a corresponding command from the encoding unit 1204 to the data store 1206 which associates the marker with the media data being received from the camera 1205.

Once the data store 1206 receives the supporting elements, they are stored in the data store 1206 for searching and playback. The web server 1203 may also read the supporting elements from the data store 1206 and send them to the broadcaster 1207 so they can be displayed to the web clients 1208, 1209 and 1210 in a presentation configuration such as the one depicted in a system 1100 shown in FIG. 11.

To pause the recording session, a PAUSE command may be sent from the computing device 1201 to the web server 1203, sending a PAUSE message from the web server 1203 to the encoding unit 1204, the encoding unit 1204 receiving the PAUSE message and sending a corresponding message to the camera 1205, the camera 1205 receiving the PAUSE command and pausing the media data recording. This paused recording mode continues until a new command is received from the encoding unit 1204 to the camera 1205.

If another PAUSE command is sent from the computing device 1201 to the web server 1203, sending a second PAUSE message from the web server 1203 to the encoding unit 1204, the encoding unit 1204 receiving the second PAUSE message and sending a corresponding second message to the camera 1205, the camera 1205 receiving the second PAUSE command and resuming the media data recording. This recording mode continues until a new command is received from the encoding unit 1204 to the camera 1205, such as another pause or a stop command.

To stop the recording session, a STOP command may be sent from the computing device 1201 to the web server 1203, sending a STOP message from the web server 1203 to the encoding unit 1204, the encoding unit 1204 receiving the STOP message and sending a corresponding message to the camera 1205, the camera 1205 receiving the STOP command and halting the media data recording. The system does not record a session until a new command is received from the encoding unit 1204 to the camera 1205. Once the recording has been stopped, the supporting elements for the media data may be associated with the media data and the media data file may be placed on the system designated by the one or more configurable paths described in FIG. 7.

A portion of the possible supporting elements, as described, may include slide show images. For example, a presentation may be running from a presenter's computing device, displayed on a projection screen. The listeners see the slide presentation and are able to hear and see the speaker. The one or more cameras described could be focused on the speaker while a software tool may be running on the presenter's computing device, not necessarily directly associated with the running application, which determines one or more screen elements have changed, captures an image of the screen, the time associated with the capture in the presentation time, and sending the screen capture to the receiving web server 1203. The web server 1203 receiving the screen capture and the relative time associated with the presentation and storing this in the data store 1206.

Therefore, during the presentation playback, the screen elements, including screen captures are shown with the other supporting elements and the media file presentation to the user. This is done by the web server 1203, once the screen capture or other supporting element has been received; it stores the timestamp of the file association and inserts this into the master synchronization file. The master synchronization file, having the path to the screen capture and the time of the screen capture, relates the pointer in the media file to the screen capture or other supporting element so that the user sees both the media file playback and the screen capture at the same time on the same or various screens.

Again, the communication and control of the presentation, START, PAUSE, MARK, STOP, etc. may be performed using an external, not physically connected electronic device which is designed to send signals to the web server 1203 and/or the encoding unit 1204, the web server 1203 and/or encoding unit 1204 enabled to receive and decipher these signals.

In addition, the playback point or interest for each of the independent web client viewers 1208, 1209, and 1210 may be different based on the search criteria and interests of the one or more users viewing the material. The web client viewers 1208, 1209, and 1210 may also have the ability to place their own marker points based on their interests as the presentation is being recorded. In this manner, each of the 1208, 1209, and 1210 have their own playback points available to them. These playback points can be stored in the data store 1206 and viewed by each independent web client viewer 1208, 1209, and 1210 at the time of playback.

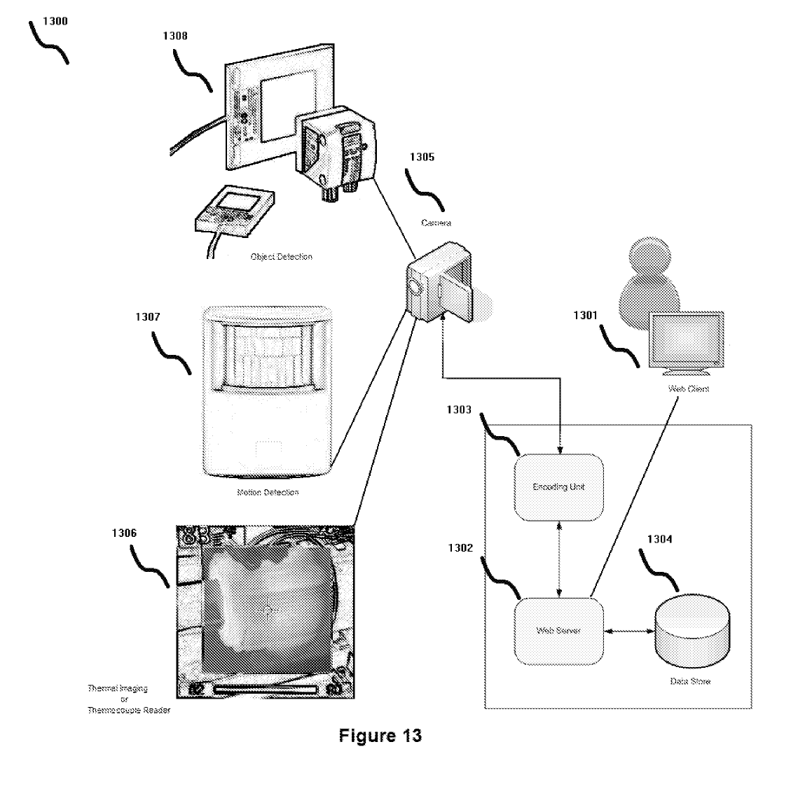

Referring now to FIG. 13, an example depiction of the instant invention is shown having a connection to one or more other devices such as an object detection system 1308, a motion detection system 1307, a thermal imaging system 1306, as well as other system not shown in a system 1300. The other devices 1306, 1307, and 1308 described are depicted as attached to the one or more cameras 1305, however, these could be connected to the encoding unit 1303 or the web server 1302 and these are connected to the camera 1305 for illustration purposes only. The other devices 1306, 1307, and 1308 described could also be an integral part of the one or more cameras 1305 wherein communication between the other devices 1306, 1307, and 1308 and the encoding unit 1303 happen directly and not through the camera 1305.

Other connected equipment for video and/or audio capture, some externally connected equipment, as shown in system 1300, may be used to provide additional data which may be synchronized to the captured video/audio streams. For example, one or more thermal detectors 1306 can be used to record temperature readings and send these readings back to the one or more encoding units 1303. Messages including these temperature records could be sent from the encoding unit 1303 to the web server 1302. This temperature records, received by the web server 1302, could then be added to the media file or data store 1304 using the timestamp based on the recording duration of the media file and could be later searched upon and/or displayed as the media file is played back. For example, if a user wanted to search for a temperature in the recording where the temperature was above 95 degrees, the search result could show the segments of the media file where the temperature was equal to or greater than the queried 95 degrees. This segments and/or temperature readings would be retrieved from the data store 1304. The playback could be received by the web client 1301.

Likewise, equipment may be used to provide additional data which may be synchronized to the captured video/audio streams related to motion, as shown in system 1300, in one or more particular areas of the media capture or the entire picture. For example, one or more motion detectors 1307, either connected as part of the camera 1305 or externally, can be used to record motion and send these readings back to the one or more encoding units 1303. This motion records could then be added to the media file and/or data store 1304 using the timestamp based on the recording duration of the media file and could be later searched upon and/or displayed as the media file is played back to the one or more web clients 1301. For example, if a user wanted to search for one or more motion readings in the recording where the motion took place either at a particular percentage of time or a particular percentage of the camera view, the search result could show the segments of the media file where the motion readings satisfied the query. In this event, the user would only see the information they were interested in and could adjust their search to find more information if needed, or watch the media file in its entirety.

In addition, equipment may be used to provide additional data which may be synchronized to the captured video/audio streams related to object detection, as shown in a system 1300, in one or more particular areas of the media capture or the entire picture. For example, one or more object detectors 1308, either connected as part of the camera 1305 or externally, can be used to record and recognize one or more objects during the media capture and send these readings back to the one or more encoding units 1303. This object detection records could then be added to the media file or data store 1304 using the timestamp based on the recording duration of the media file and could be later searched upon and/or displayed as the media file is played back to the one or more web clients 1301. For example, if a user wanted to search for one or more object detection readings in the recording where the object they were interested in was a person either over a particular amount of time or a particular percentage of the camera view, the search result could show the segments of the media file where the object detector readings satisfied the query by locating a person in the video area of interest. In this event, the user would only see the information they were interested in and could adjust their search to find more information if needed, or watch the media file in its entirety.

It should be understood that the foregoing description is only illustrative of the instant invention. Various alternatives and modifications can be devised by those skilled in the art without departing from the claims of the instant invention including, but not limited to, the use of one computing device over another, including mobile devices, or one computing device over many computing devices, cameras, etc. Accordingly, the present invention is intended to embrace all such alternatives, modifications and variances which fall within the scope of the appended claims.

What is claimed is:

1. A recording and presentation system comprising:
a computing device having at least one connection to a web server;
a web server having at least one connection to an encoding unit;
an encoding unit connected to at least one optical device;
a web server connected to at least one data store;
a system for receiving audio and video data; and
a system for receiving and/or creating and/or recording timeline pointer data; and
a system for receiving and/or creating and/or recording descriptive content; and
a system can send and/or receive one or more of the associated audio and video data and timeline pointer data to a storage; wherein the said system further can search for the timeline pointer data and/or descriptive content, the supporting elements, and present the said audio, video and supporting elements to a receiver, such as one or more displays,

2. A system in claim 1 having a web server connected to at least one media store;

3. A system in claim 1 having a web server connected to at least one broadcaster;

4. A system in claim 1 having a web server connected to at least one web client;

5. A system in claim 1 wherein the said system plays the media file, and/or audio file and/or supporting elements back to the one or more users on one or more displays at independent points elected by the one or more users,

6. A system in claim 1 wherein the said system can capture a screen and store the screen capture to storage,

7. A system in claim 2 wherein the said system can present the screen capture and the video and audio capture in a synchronized fashion on one or more displays,

8. A system in claim 1 which can provide an interactive playback to the user such as clicking on a link to view one or more segments of interest,

9. A system of claim 1 wherein the user can modify the searchable content of the media file and/or data store based on security settings,

10. A system of claim 1 wherein the user can locally or remotely transfer the media file and/or data from the data store relevant to the playback of the media file on one or more other devices,

11. A system of claim 1 wherein a remotely or locally connected thermal detector can communicate with the one or more cameras or one or more clients and/or servers,

12. A system of claim 1 wherein a remotely or locally connected motion detector can communicate with the one or more cameras or with one or more clients and/servers,

13. A system of claim 1 wherein a remotely or locally connected object detector can communicate with the one or more cameras or with one or more clients and/servers,
